(19) United States
(12) Patent Application Publication
(10) Pub. No.: US 2012/0210807 A1
(43) Pub. Date: Aug. 23, 2012

(54) TESTING MODULE

(75) Inventors: TENG-TSUNG HUANG, Tu-Cheng (TW); GUO-JUN YU, Shenzhen City (CN); YONG-BING HU, Shenzhen City (CN); YUAN-ZHAO LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/274,566

(22) Filed: Oct. 17, 2011

(30) Foreign Application Priority Data
Feb. 23, 2011 (CN) 201110044484.6

(51) Int. Cl. G01N 19/00

(52) U.S. Cl. 73/865.9

(57) ABSTRACT

A testing module includes a sleeve, a guide pole, an elastic member and a fixing member. The guide pole is slidably received in the sleeve, and the elastic member is fitted around the guide pole and received in the sleeve. The fixing member includes a main body, a first extending plate and a second extending plate. The sleeve is received in the main body, and the first extending plate and the second extending plate are positioned at two ends of the main body. The guide pole is driven to move relative to the sleeve and the fixing member.

### BACKGROUND

1. Technical Field

The present disclosure relates to testing modules, and particularly to a testing module for testing buttons of portable electronic device.

2. Description of Related Art

Input devices for portable electronic devices (e.g., mobile phones) need to be able to withstand repeated operation. Input devices can be keypads that are provided with buttons. The buttons should be tested e.g., to ensure the buttons properly contact the printed circuit board when pressed.

A known testing module includes a pressing head. The pressing head is controlled to press against the buttons directly and rigidly (i.e., without using any buffering means) by the testing module. However, this method can cause damage to the buttons. In addition, the testing module is usually fixed to a testing machine. If the testing module breaks down, it is not easy to detach it from the testing machine for repair or replacement.

Therefore, there is room for improvement within the art.

### BRIEF DESCRIPTION OF THE DRAWINGS

Many aspects of the testing module can be better understood with reference to the following drawings. The components in the drawings are not necessarily drawn to scale, the emphasis instead being placed upon clearly illustrating the principles of the testing module. Moreover, in the drawings, like reference numerals designate corresponding parts throughout the several views.

FIG. 1 is an exploded, isometric view of one embodiment of a testing module.

FIG. 2 is an enlarged view of a fixing member.

FIG. 3 is an assembled view of the testing module shown in FIG. 1.

FIG. 4 is a state view of the testing module in use.

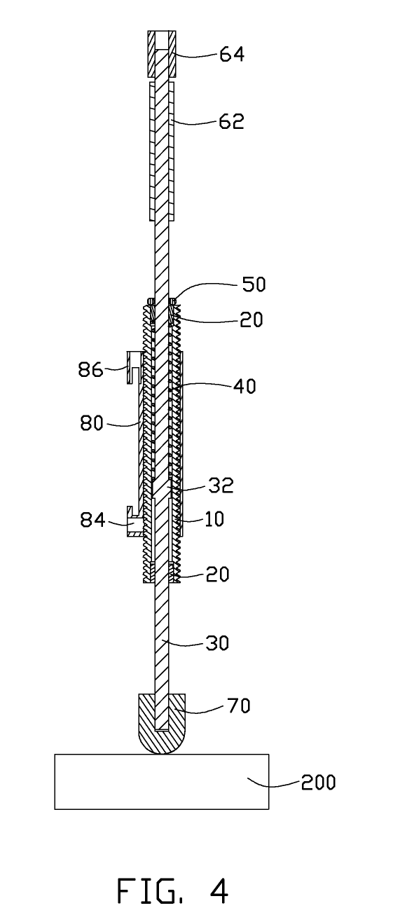

### DETAILED DESCRIPTION

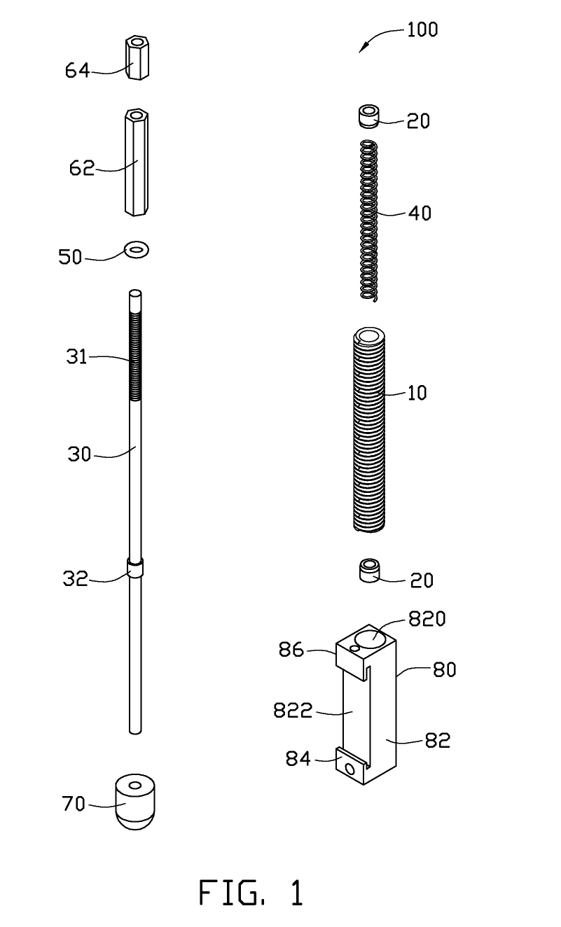

An exemplary testing module 100 shown in FIG. 1 can be suitably used for testing e.g., buttons of keypads of mobile phones. The testing module 100 embodied in FIG. 1 includes a sleeve 10, two stopper members 20, an externally threaded guide pole 30, an elastic member 40, a washer 50, a first and a second adjusting member 62, 64, a pressing head 70, and a fixing member 80.

A number of ring-shaped protrusions are formed on an outer wall of the sleeve 10 for tightly engaging with the fixing member 80. The stopper members 20 are respectively positioned at opposite ends of an inner peripheral wall of the sleeve 10.

The guide pole 30 is slidably received in the sleeve 10. The guide pole 30 has a threaded end 31. A flange 32 is formed on a middle lower portion of the guide pole 30. When the guide pole 30 slides to a limited position relative to the sleeve 10, the flange 32 abuts against one of the stopper members 20 to prevent the guide pole 30 separating from the sleeve 10. The elastic member 40 is a helical spring, and is fitted around the guide pole 30. When the elastic member 40 is an original state, one end of the elastic member 40 abuts against the flange 32, and the other end abuts against the stopper member 20. The washer 50 is fitted around the guide pole 30 for resisting one end of the sleeve 10 and one of the stopper members 20.

In this embodiment, the first and second adjusting members 62, 64 are nuts that screw onto the threads of guide pole 30. The first adjusting member 62 is longer than the second adjusting member 64, and is disposed between the washer 50 and the second adjusting member 64. The adjusting members 62, 64 are threaded to the threaded end 31 of the guide pole 30. The first adjusting member 62 is used for keeping the elastic member 40 at a predetermined length. The second adjusting member 64 can prevent loosening of the first adjusting member 62. The pressing head 70 is mounted to an end of the guide pole 30 opposite to the first and second adjusting members 62, 64 for pressing a button of a keypad 200.

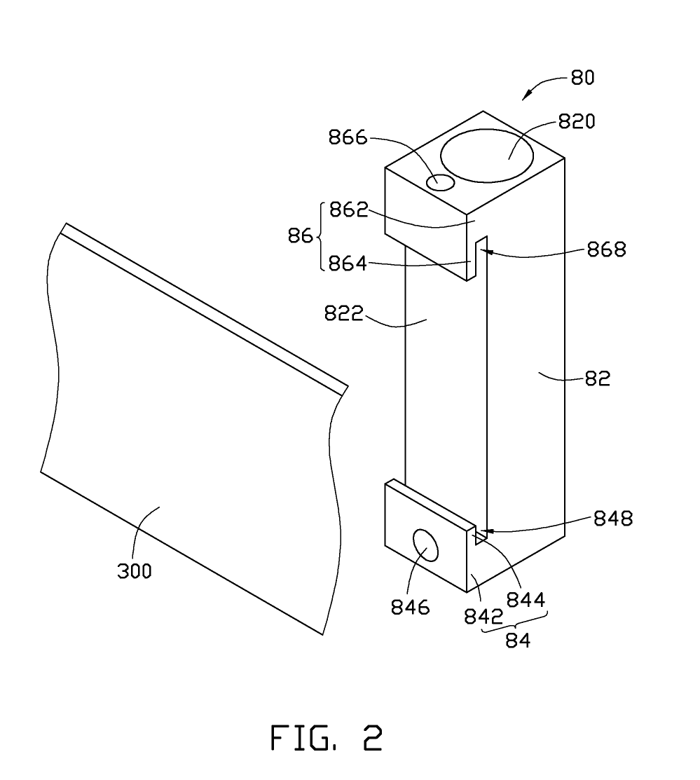

Referring to FIG. 2, the fixing member 80 attaches to a support member 300 of a testing machine. The fixing member 80 includes a main body 82, a first extending plate 84 and a second extending plate 86. The main body 82 defines a through hole 820 along a vertical direction thereof for receiving the sleeve 10. The first extending plate 84 and the second extending plate 86 respectively extend from opposite ends of the fixing member 80, and are formed above a side surface 822 of the main body 80. The first extending plate 84 is substantially L-shaped, and includes a connecting end 842 and a latching end 844. The connecting end 842 is formed on the main body 80, and the latching end 844 defines a positioning hole 846 communicating with the through hole 820. This positioning hole 846 is configured for positioning the fixing member 80 on the sleeve 10 with a pin. The latching end 844 is parallel to the side surface 822, and a first groove 848 is defined between the latching end 844 and the side surface 822. The second extending plate 86 is substantially L-shaped, and also includes a connecting end 862 and a latching end 864. The latching end 864 is parallel to the side surface 822, and a second groove 868 is defined between the latching end 864 and the side surface 822. The connecting end 862 defines a latching hole 866 communicating with the second groove 868. When the fixing member 80 is hung on the support member 300, the first and second extending plates 84, 86 are latched on the support member 300. In order to prevent relative movement between the support member 300 and the fixing member 80, a fastener (not shown) may be inserted into the latching hole 866 to abut against the support member 300.

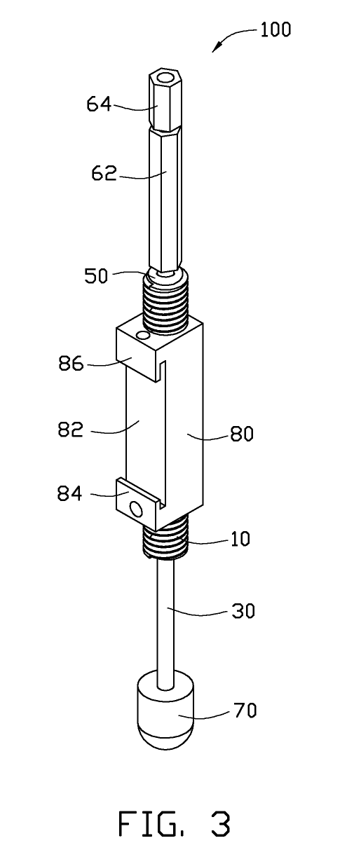

Referring to FIG. 3, during assembly, the elastic member 40 is fitted around the guide pole 30, and the guide pole 30 extends through the sleeve 10. The stopper members 20 are respectively attached to opposite ends of the sleeve 10. The washer 50, the first and second adjusting members 62, 64 are assembled on the threaded end 31 of the guide pole 30. The pressing head 70 is mounted on the opposite end of the guide pole 30. The fixing member 80 is fitted around the sleeve 10. Thus, the testing module 100 is completely assembled. The pin is inserted into the positioning hole 846 to mount the fixing member 80 to the sleeve 10.

To test buttons on a keypad, a plurality of testing modules 100 are hung on the support member 300 according to an arrangement of the test keypad. A fastener is inserted into a corresponding latching hole 866 to abut against the support member 300 to prevent the relative movement between the support member 300 and the fixing members 80. The test machine drives the support member 300 to move up and down, so that the pressing heads 70 press the buttons of the keypad 200 repeatedly. The guide poles 30 are essentially spring-loaded and elastically retract when pressed against the keypad 200 so that there is some give and the pressure against the keypad is not so great as to cause damage. In addition, the testing modules can easily be detached from the support member 300.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A testing module, comprising:
a sleeve;
a guide pole slidably received in the sleeve;
an elastic member fitted around the guide pole and received in the sleeve;
a fixing member including a main body, a first extending plate and a second extending plate, the sleeve received in the main body, and the first extending plate and the second extending plate positioned at two ends of the main body, the guide pole driven to move relative to the sleeve and the fixing member.

2. The testing module as claimed in claim 1, wherein the main body defines a through hole along a vertical direction thereof for receiving the sleeve.

3. The testing module as claimed in claim 2, wherein the first extending plate is substantially L-shaped, and includes a connecting end and a latching end, the connecting end is formed on the main body, and the latching end defines a positioning hole communicating with the through hole.

4. The testing module as claimed in claim 3, wherein the second extending plate is substantially L-shaped, and also includes a connecting end and a latching end, a second groove is defined between the latching end and the main body.

5. The testing module as claimed in claim 4, wherein the connecting end defines a latching hole communicating with the second groove.

6. The testing module as claimed in claim 1, wherein a flange is formed on a middle lower portion of the guide pole.

7. The testing module as claimed in claim 1, further comprising two stopper members, wherein the stopper members are respectively positioned at opposite ends of an inner peripheral wall of the sleeve.

8. The testing module as claimed in claim 1, further comprising a first adjusting member and a second adjusting member, wherein the first adjusting member and the second adjusting member are attached to one end of the guide pole.

9. The testing module as claimed in claim 8, wherein the first adjusting member is longer than the second adjusting member.

10. A testing machine comprising:
a support member;
a plurality of testing modules, each testing module comprising:
a sleeve;
a guide pole slidably received in the sleeve;
an elastic member fitted around the guide pole and received in the sleeve;
a fixing member including a main body, a first extending plate and a second extending plate, the sleeve received in the main body, and the first extending plate and the second extending plate positioned at two ends of the main body and being latched in the support member, the guide pole driven to move relative to the sleeve and the fixing member.

11. The testing machine as claimed in claim 10, wherein the main body defines a through hole along a vertical direction thereof for receiving the sleeve.

12. The testing machine as claimed in claim 11, wherein the first extending plate is substantially L-shaped, and includes a connecting end and a latching end, the connecting end is formed on the main body, and the latching end defines a positioning hole communicating with the through hole.

13. The testing machine as claimed in claim 12, wherein the second extending plate is substantially L-shaped, and also includes a connecting end and a latching end, a second groove is defined between the latching end and the main body.

14. The testing machine as claimed in claim 13, wherein the connecting end defines a latching hole communicating with the second groove.

15. The testing machine as claimed in claim 10, further comprising two stopper members, wherein the stopper members are respectively positioned at opposite ends of an inner peripheral wall of the sleeve.

16. The testing machine as claimed in claim 10, further comprising a first adjusting member and a second adjusting member, wherein the first adjusting member and the second adjusting member are attached to one end of the guide pole.

17. The testing machine as claimed in claim 16, wherein the first adjusting member is longer than the second adjusting member.
